(19) United States
(12) Patent Application Publication
(10) Pub. No.: US 2004/0025851 A1
(43) Pub. Date: Feb. 12, 2004

(54) Device for metered admixing of volatized fuel in an intake manifold of an internal combustion engine

(76) Inventors: Erwin Krimmer, Pluederhausen (DE); Wolfgang Schulz, Bietigheim-Bissingen (DE); Achim Meisiek, Rudersberg (DE)

Correspondence Address: STRIKER, STRIKER & STENBY, 103 East Neck Road, Huntington, NY, 11743, US

(21) Appl. No.: 10/443,705

(22) Filed: May 22, 2003

(30) Foreign Application Priority Data
Aug. 8, 2002 (DE) 102 36 387.0

(51) Int. Cl. F02M 17/22

(52) U.S. Cl. 123/522

(57) ABSTRACT

With metered admixing of volatized fuel in an intake manifold of an internal combustion engine with a supercharger, the problem exists that depending on the respective operating state, different pressures prevail in the intake manifold. This problem is resolved in known devices, in that return valves are subsequently added and structurally separated from the tank aeration valve in the flow direction. The present invention proposes that the return valves (39, 40) are structurally integrated in a tank aeration valve (5), in order to reduce the assembly expense and the spatial requirements.

### BACKGROUND OF THE INVENTION

The present application relates to a device for the metered admixing of volatized fuel in an intake manifold of an internal combustion engine.

From DE 40 23 044 A1, a tank aeration valve is known, in which for the use in so-called supercharged aero engines or blower-fed engines, a return valve is integrated on the outlet side. Since in turbo operation, the necessary negative pressure does not prevail in an inlet manifold, in order to produce a flow from an activated charcoal filter in the direction of the intake manifold for a regeneration of an activated charcoal filter, rather, a similarly high excess pressure, a return or return valve is placed in the tank aeration valve on the outlet side, which closes in turbo operation and thereby prevents a back flow from the intake manifold in the direction of the activated charcoal filter. A regeneration of the activated charcoal filter in turbo operation is therefore not possible. This is particularly disadvantageous, since with today's supercharged aero engines, the turbo operation makes up more than 80% of the operating time.

From DE 43 11 316 C1, a device is known that comprises a tank aeration valve and a separate valve housing with two return valves, which remedies these disadvantages. The separate valve housing has an inlet channel and two outlet channels, whereby one of the outlet channels is connected with the suction side of the supercharger and the other outlet channel is connected with the pressure side of the super charge downstream of a throttle valve. In each outlet channel, a return valve is provided, so that one of the outlet channels can flow only in the direction of the suction side of the supercharger and the other outlet channel can only flow in the direction of the pressure side of the supercharger. In turbo operation, an over pressure prevails down stream of the supercharger in the intake manifold, so that the return valve connected with the pressure side closes, while the return valve connected with the suction side of the supercharger opens and the volatized fuel can be supplied from a fuel tank to the internal combustion engine. In this manner, the activated charcoal filter can be regenerated in turbo operation. This solution of the structural separation from the magnetic valve and the valve housing with two return valves still has the disadvantage that the manufacturing costs and the assembly costs are similarly high and in addition, additional lines and much space is required.

### SUMMARY OF THE INVENTION

The device of the present invention, in contrast, has the advantage that in a simple manner, a simplification is cost-effectively achieved, in which the tank aeration valve and the two return valves are integrated in or with a housing and thereby, connection lines from the tank aeration valve to the separate valve housings with the return valves can be eliminated, which substantially simplifies assembly and offers a significant cost savings as a result.

It is advantageous if the first housing part is cup-shaped, in order to enable a spatially good arrangement of the valve body and an actor.

In addition, it is advantageous if the second housing part is cover-shaped on space-saving grounds.

It is particularly advantageous if a return valve is arranged on each of the two outlet connections on the side facing the tank aeration valve, since this substantially simplify the assembly of the tank aeration valve.

It is also advantageous if one of the outlet connections is pluggable for the insertion of the intake manifold in a cylindrical opening, since in this manner, the assembly of the tank aeration valve on the internal combustion engine is greatly simplified and, for example, a hose connection is dispensable.

In addition, it is advantageous to provide a flow element, for example, a laval nozzle, in the two outlet channels.

### BRIEF DESCRIPTION OF THE DRAWINGS

One embodiment of the invention is shown in the drawings and is described in more detail in the subsequent description.

FIG. 1 shows a device for tank aeration for an internal combustion engine with a supercharger; and

FIG. 2 shows the device of the present invention in a longitudinal section.

### DETAILED DESCRIPTION OF THE PREFERRED EMBODIMENTS

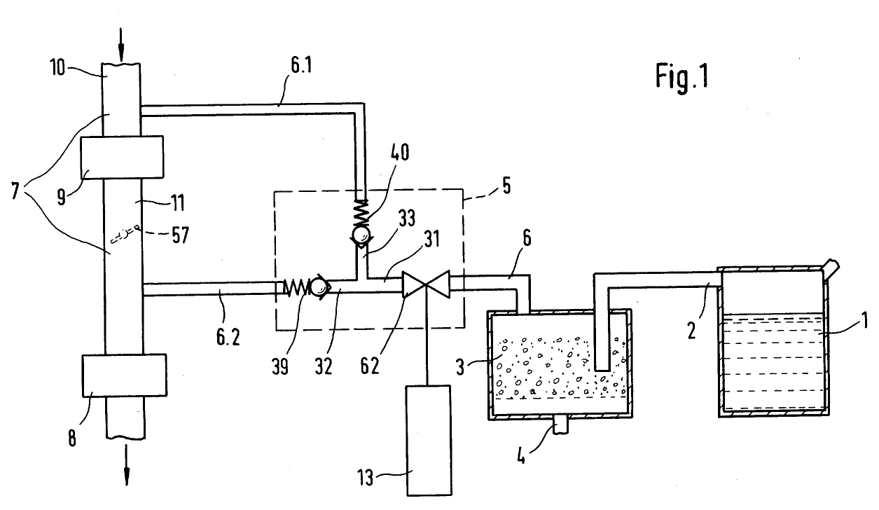

FIG. 1 shows a device for ventilation of a fuel tank 1. A ventilation channel 2 of the fuel tank I is connected to a storage unit 3 filed with activated charcoal, for example, which temporarily absorbs the volatized fuel from the fuel tank 1. Before the absorption capacity of the storage unit 3 is depleted, in a regeneration phase, a control valve 62 of a tank aeration valve 5 located in a discharge line 6 is opened, so that by a negative or low pressure in an intake manifold 7, air from the surrounding environment is sucked in via a ventilation opening 4 provided on the storage unit 3 and flows through the storage unit 3. The activated charcoal supplied thereby the absorbed fuel to the air. The fuel-air mixture formed in this manner is also designated as a tank aeration mixture or regenerating gas. The regenerating gas arrives in the regeneration phase via the tank aeration valve 5 in the intake manifold 7 of an internal combustion engine 8 with a supercharger 9. In this manner, the regenerating gas, depending on the operation state of the internal combustion engine 9, is either mixed with the suction air in the intake manifold 7 upon supercharger operation via a first discharge line section 6.1 on a suction side 10 of the charger 9 or with the manner of operation, with a still charger 9, via a second discharge line section 6.2 on a pressure side 11 of the charger downstream of a throttle valve 57. A control apparatus 13 controls the volume of the regenerating gas to be mixed over an opening time of the control valve 62. In this manner, the control valve 62 can be cyclically controlled by alternating opening and closing.

After the end of the regeneration phase, the absorption capacity of the storage unit 3 is restored and the storage unit 3 can again absorb fuel. In the tank aeration valve 5, a first return valve 39 and a second return valve 40 are arranged near the control valve 62. The first return valve 39 closes upon charger operation and prevents therewith a back flow of the intake or suction air from the intake manifold 7 in the storage unit 3. The second return valve 40 opens upon charger operation and makes possible in this manner that also with a charger operation, a regeneration phase can take place. Outside of the charger operation, the first return valve 39 is opened and the second return valve 40 is closed.

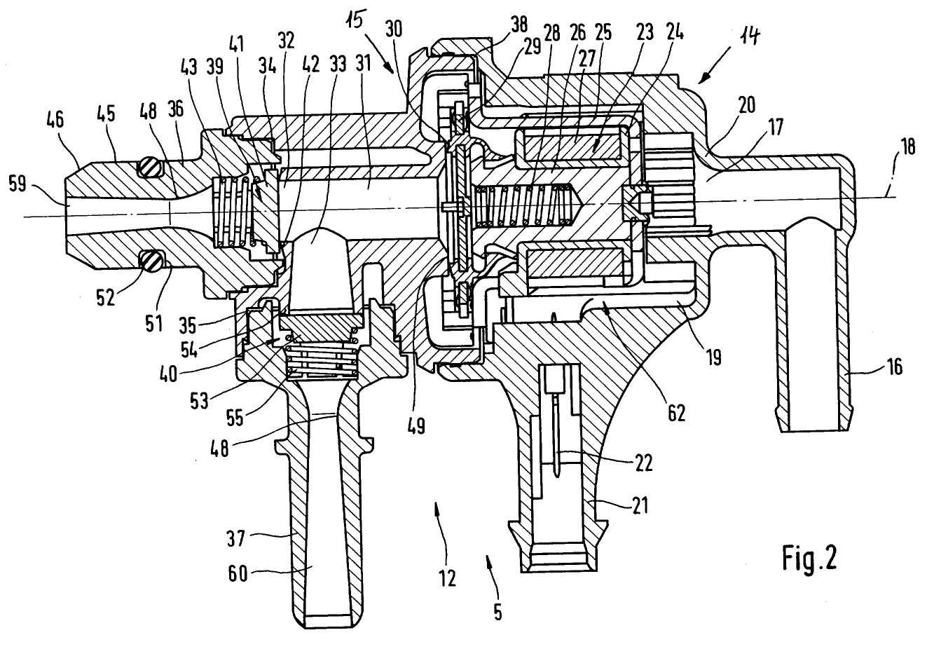

FIG. 2 shows the tank aeration valve 5 in longitudinal section. The tank aeration valve 5 comprises, for example, a two-part housing 12 with a first housing part 14, which, for example, is cup-shaped, and with a second housing part 15, which, for example, is cover-shaped. The first housing part 14 has an inlet connection 16 for connection via the discharge line 6 to the storage unit 3 that is filled with activate charcoal, for example, for the volatized fuel. The inlet connection 16 has an opening 17 in an inner chamber 19 in the region of a floor 20 of the cup-shaped first housing part 14. The first housing part 14 has, for example, on its periphery a plug 21 that is connected as one-piece with the first housing part 14, which has a connection element 22 for connecting to an outside plug contact.

In the inner chamber 19 of the cup-shaped first housing part 14, the control valve 62, which is actuated by an actor, with a valve member 29 and a sealing seat 49 is arranged. The actor, for example, is an electromagnet 32. The electro-magnet 23, for example, has a cup-shaped magnet housing 25 with a cylindrical magnet core 26 that penetrates the cup floor and is coaxial to a valve axis 18 and which has a cylindrical field coil 27, which sits on a coil support 24, which surrounds the magnet core 26 in the magnet housing 25. On side of the magnet core 26 facing the second housing part 15, a valve member 29 that is adjustable counter to the return for of a return spring 28. The valve member 29 is activated by the electromagnets 23 and is an armature plate, which comes into contact with the sealing seat 49 arranged directly or indirectly on the second housing part 15. On the armature plate 29 forming a valve member, further, a sealing and damping member 30 is arranged. The sealing and damping member 30 is arranged on the armature plate 29 and on the magnet core 26 and connects these elements to one another as an elastic element.

The second housing part 15, for example, is centrally arranged in a recess 38 of the first housing part 14 and connected thereto. As viewed in the flow direction, a channel 31 formed in the second housing part 15 connects to the armature plate 29 downstream of the sealing seat 49. The channel 31 branches off in a first channel 32 and a second channel 33, whereby the first channel 32, for example, ends in a first recess 34 and the second channel 33 ends in a second recess 35 of the second housing part 15. In the first recess 34, a first outlet connection 36 with a first outlet channel 49 is partially arranged and in the second recess 35, a second outlet connection 37 with a second outlet channel 60 is partially arranged. The first outlet channel 59 is connected with the first channel 32, and the second outlet channel 60 is connected to the second channel 33. Both outlet connections 36, 37 are welded or adhered or screwed, for example, to the second housing part 15. In the first outlet channel 59, a first return valve 39 is arranged on the side facing the second housing part 15. The first return valve comprises a first valve body 41, a first valve seat 42, and a first return spring 43. In the second outlet channel 60, a second return valve 40 is arranged, the second return valve 40 comprising a second valve body 53, a second valve seat 54, and a second return spring 55. In this manner, the valve seats 42 and 54 are formed on the second housing part 15. The return valves 39 and 40 both close against a flow direction by a control valve 62 to the outlet connections 36, 37.

In addition, the first outlet channel 59 has a flow element 48, for example, a laval nozzle. The flow element 48, however, is not limited to a laval nozzle and also can be embodied as a screen or throttle. The flow element 48 is formed such that the surface of its narrowest flow cross section is smaller than the surface of the opening cross section of the sealing seat 49. Also, the flow element 48, for example, a laval nozzle, can be arranged in the second outlet channel.

On the outer circumference of the first outlet connection 36, a cylindrical section 45 is arranged, in which a groove 51 for receiving a sealing ring 52 is located. For the assembly on the internal combustion engine 8, the first inlet connection 36 of the tank aeration valve 5 needs only to be inserted into an opening of the intake manifold 7 downstream of the charger 9. A fiber 46 facilitates this assembly step.

FIG. 1 shows that the tank aeration valve 5 is connected via the discharge line 6.2 with the intake manifold 7 downstream of the charger 9. The discharge line 6.2 can be a line, for example, a hose, which connects the first outlet connection 36 with the intake manifold 7 downstream of the throttle valve 57. If the tank aeration valve 5 is inserted instead with the first outlet connection 36 into an opening of the intake manifold 7, than the first outlet channel 59 is also simultaneously the discharge line 6.2

The second outlet connection 37 is connected with the intake manifold 7 by means of a discharge line 6.1 downstream of the charger 9. The discharge line 6.1 can be a hose connection, for example.

The first return valve 39 of the first outlet connection 36 opens against the force of the first return spring 43 at a negative pressure predetermined by the force of the first return spring 43 in the intake manifold 7 downstream of the throttle valve 57. The negative pressure in the intake manifold 7 downstream of the throttle valve 57 is sufficiently large to open the first return valve 39 in the manner of operation of the internal combustion engine 8, in which the charge 9 rests. Since, with an opened first return valve 39, the pressure in the second channel 33 is smaller then downstream of the second return valve 40 in the second outlet channel 60, the second return valve 40 closes approximately simultaneously with the opening of the first return valve 39.

In operation of the supercharger, an overpressure prevails in the intake manifold 7 on the pressure side 11 of the supercharger 9 downstream of the throttle valve 57, so that the first return valve 39 closes. The negative pressure in the intake manifold 7 on the suction side 10 of the supercharger 9 opens approximately simultaneously with the second return valve 40.

The housing 12 and the outlet connections 36 and 37 are made of plastic, for example.

It will be understood that each of the elements described above, or two or more together, may also find a useful application in other types of constructions differing from the types described above.

While the invention has been illustrated and described herein as a device for metered admixing of volatized fuel in an intake manifold of an internal combustion engine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for metered admixing of a volatized fuel from a fuel tank of an internal combustion engine in an intake manifold of the internal combustion engine, with a valve with a sealing seat that can be actuated by an actor, a housing, and at least two return valves operated in parallel downstream of the sealing seat, characterized in that the at least two return valves (39, 40) are arranged on the valve (5).

2. The device according to claim 1, characterized in that the housing (12) comprises at least one first housing part (14) and one second housing part (15).

3. The device according to claim 2, characterized in that the first housing part (14) is cup-shaped.

4. The device according to claim 2, characterized in that the first housing part (14) has an inlet connection (16) and a plug (21) for an electrical connection.

5. The device according to claim 2, characterized in that the second housing part (15) is cover-shaped.

6. The device according to claim 2, characterized in that on the second housing part (15), a first outlet connection (36) and a second outlet connection (37) are arranged.

7. The device according to claim 6, characterized in that on the first outlet connection (36) and on the second outlet connection (37) on a side facing the second housing part (15), a respective return valve is arranged (36, 37).

8. The device according to claim 6, characterized in that the first outlet connection (36) is a pluggable connection for mounting in a cylindrical opening of the intake manifold (7).

9. The device according to claim 6, characterized in that the first outlet connection (36) has a first outlet channel (59) and the second outlet connection (37) has a second outlet channel and in at least one of the two outlet channels (59, 60), a flow element (48) is provided.

10. The device according to claim 9, characterized in that the flow element (48) is a laval nozzle.
